(19) United States
(12) Patent Application Publication
(10) Pub. No.: US 2023/0123399 A1
(43) Pub. Date: Apr. 20, 2023

(54) SERVICE PROVIDER SELECTION

(71) Applicant: International Business Machines Corporation, Armonk, NY (US)

(72) Inventors: Shikhar Kwatra, San Jose, CA (US); ALY MEGAHED, San Jose, CA (US); Shubhi Asthana, Santa Clara, CA (US); Indervir Singh Banipal, Austin, TX (US); MOHAMED MOHAMED, San Jose, CA (US); Hovey Raymond Strong, San Jose, CA (US); SAMIR TATA, Santa Clara, CA (US)

(21) Appl. No.: 17/500,994

(22) Filed: Oct. 14, 2021

(51) Int. Cl. G06Q 30/06; G06N 20/00

(52) U.S. Cl. CPC G06Q 30/0609; G06N 20/00

(57) ABSTRACT

A computer implemented method for selecting service providers includes receiving a set of client requirements and analyzing available service providers based on the received set of client requirements. The method additionally includes scoring the available service providers based on the analysis. The method further includes identifying one or more unstructured external data sources corresponding to the available service providers and analyzing the reliability of the one or more unstructured external data sources with respect to the available service providers. The method further includes adjusting the scoring of the service providers based, at least in part, on the data source reliability, and subsequently providing an optimal selection of service providers based on the adjusted scoring. A computer program product and computer system corresponding to the method are also disclosed.

### BACKGROUND

The present invention relates generally to the field of confederated platform management, and more specifically to identifying optimal service providers with respect to a client's requirements.

Cloud federation refers to a group of one or more cloud environments connected via one platform. Providers who are members of a federation can advertise their services using a registry or catalog that may show information about the services and their providers. A consumer may have a set of requirements laid out by manifests or agreements, as well as constraints corresponding to those requirements, such as cost, availability zones, resource preferences, etc. A federation may have a broker that can help a consumer identify a best fit for their requirements. The broker may allow mapping of consumer requirements and provider service offerings.

### SUMMARY

As disclosed herein, a computer implemented method for selecting service providers includes receiving a set of client requirements and analyzing available service providers based on the received set of client requirements. The method further includes identifying one or more unstructured external data sources corresponding to the available service providers and analyzing the reliability of the one or more unstructured external data sources with respect to the available service providers. The method further includes adjusting the scoring of the service providers based, at least in part, on the data source reliability, and subsequently providing an optimal selection of service providers based on the adjusted scoring. A computer program product and computer system corresponding to the method are also disclosed.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 is a block diagram depicting a service selection system in accordance with at least one embodiment of the present invention;

FIG. 4 is a flowchart depicting a service selection method in accordance with at least one embodiment of the present invention; and

FIG. 5 is a block diagram of components of a computing system in accordance with an embodiment of the present invention.

### DETAILED DESCRIPTION

In an environment (e.g., a federated cloud environment) in which a client exhibits a set of requirements, each of said requirements can have one or more constraints. For example, a client might require two services running in a same availability zone or coming from a same provider. Said customer may additionally require to have a fixed number of instances for some services, and may be constrained by a price range for each service. Information regarding provider capabilities may be similarly convoluted; for example, Quality of Service (QoS) information regarding the provider capabilities may be available as both structured data captured by monitoring the provider systems as well as unstructured data provided by expert reports, reviews, news outlets, etc. Existing methods for determining optimized deployment of services falter in the presence of a complicated set of requirements and constraints.

The present invention will now be described in detail with reference to the Figures. Implementation of embodiments of the invention may take a variety of forms, and exemplary implementation details are discussed subsequently with reference to the Figures.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

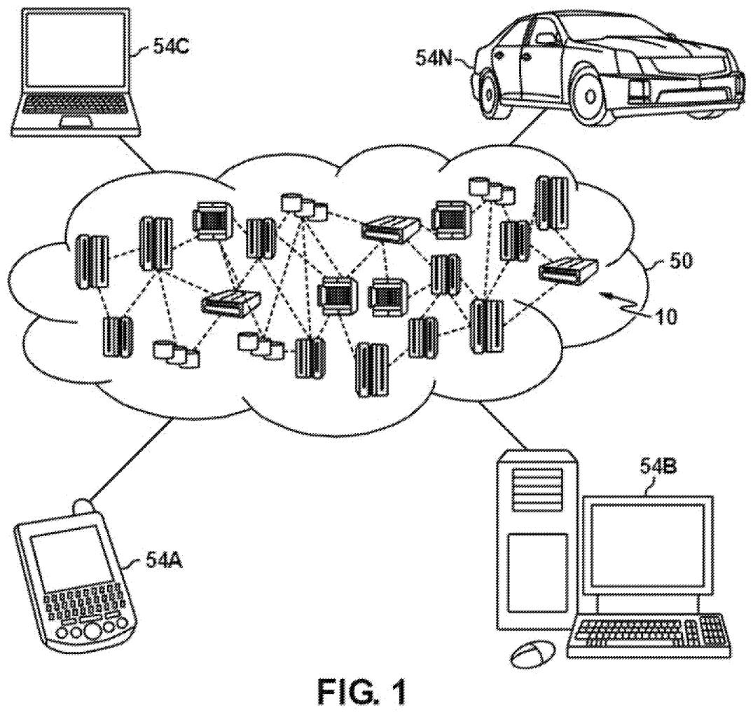

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

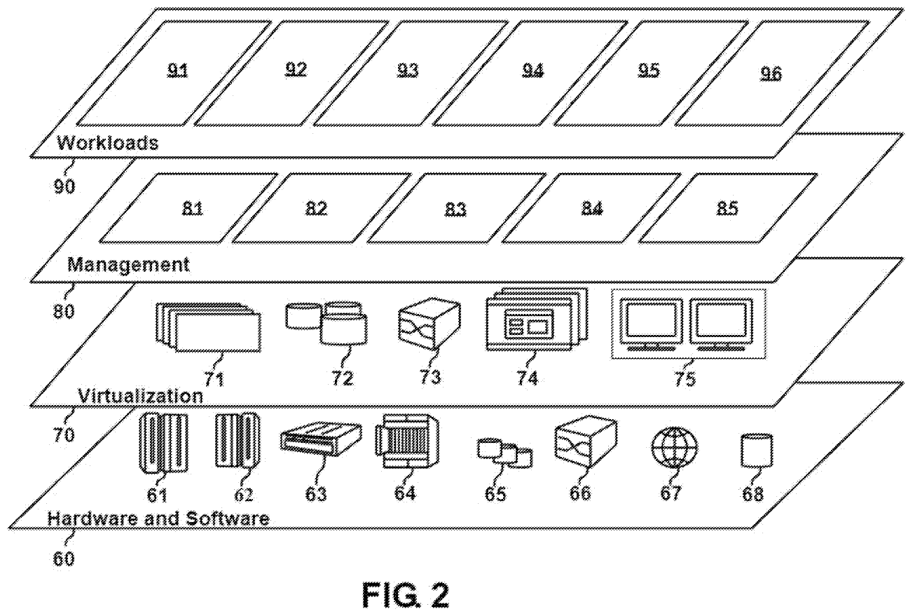

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and platform analysis 96.

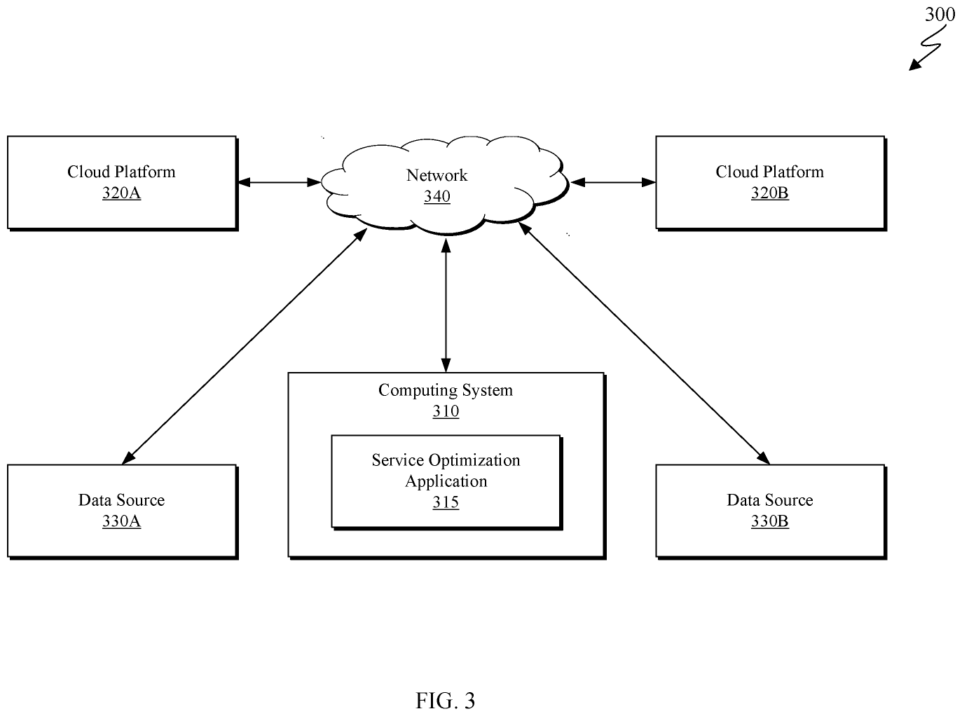

FIG. 3 is a block diagram depicting a cloud selection system 300 in accordance with at least one embodiment of the present invention. As depicted, cloud selection system 300 includes computing system 310, cloud platforms 320A and 320B, data sources 330A and 330B, and network 340. It should be appreciated that cloud selection system 300 may be implemented in any number of cloud environments, including, but not limited to, hybrid cloud and multi cloud platforms. It should therefore be appreciated that the depicted embodiment of cloud selection system 300 and the corresponding structure with which the various applications are depicted relative to one another are not intended to be limiting, but rather provide just one example of a system capable of executing the methods disclosed herein.

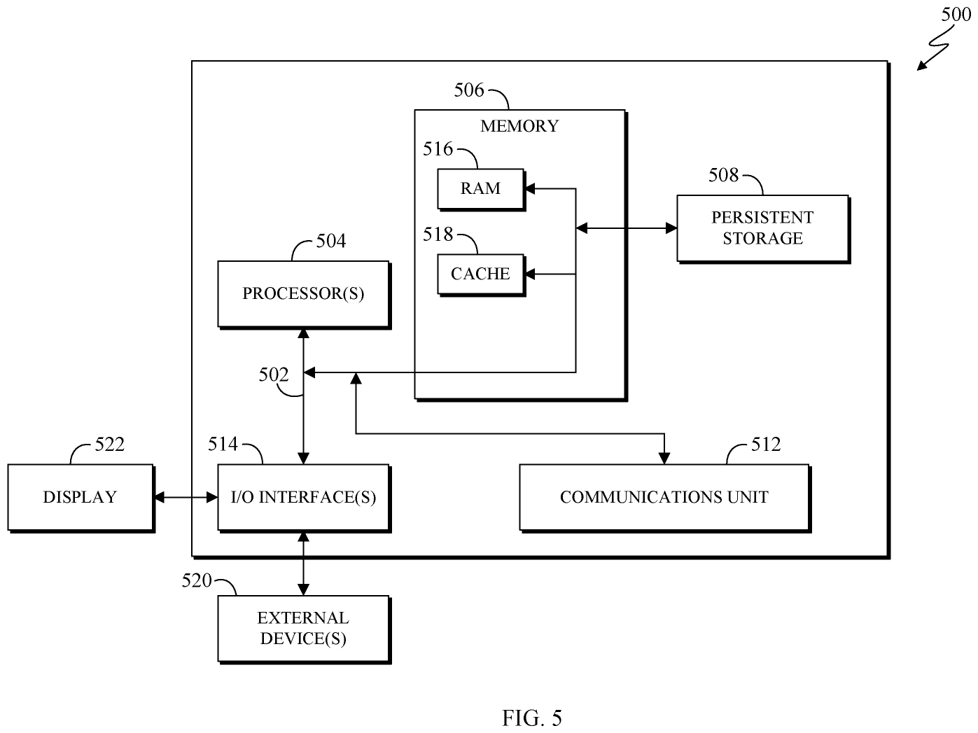

Computing system 310 can be a desktop computer, a laptop computer, a specialized computer server, or any other computer system known in the art. In some embodiments, computing system 310 represents computer systems utilizing clustered computers to act as a single pool of seamless resources. In general, computing system 310 is representative of any electronic device, or combination of electronic devices, capable of receiving and transmitting data, as described in greater detail with regard to FIG. 5. Computing system 310 may include internal and external hardware components, as depicted and described in further detail with respect to FIG. 5.

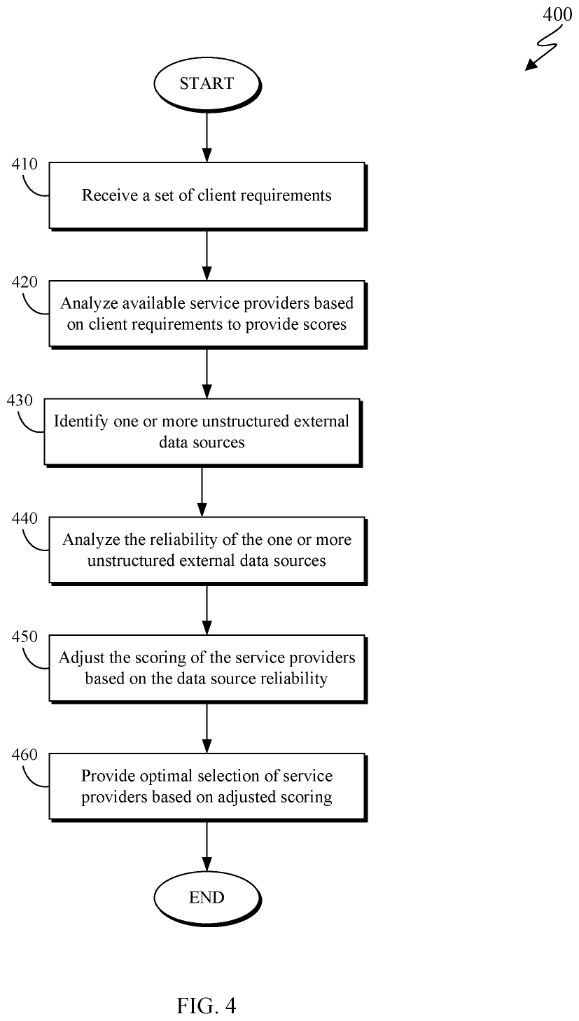

As depicted, computing system 310 includes platform optimization application 315. Platform optimization application 315 may be configured to execute a service selection method to identify an optimal set of services corresponding to a client's requirements. One example of an appropriate service selection method is described in detail with respect to FIG. 4.

Cloud platform 320A and cloud platform 320B each represent a service provider platform through which services are available to a client. In general, cloud platforms 320 are service providers via which computer system resources are available on demand to the client. Cloud platforms 320 may each refer to a cloud federation, an individual cloud platform or cloud system, or any other system via which cloud services are made available to a client. With respect to the depicted embodiment, cloud platforms 320 are configured to communicate with computing system 310 (and service optimization application 315) via network 340, and are accordingly configured to provide and receive data accordingly.

Data sources 330 may be configured to store received information and can be representative of one or more databases that give permissioned access to computing system 310 or publicly available databases. In general, data sources 330 can be implemented using any non-volatile storage media known in the art. For example, data sources 330 can be implemented with a tape library, optical library, one or more independent hard disk drives, or multiple hard disk drives in a redundant array of independent disk (RAID).

Network 340 can be, for example, a local area network (LAN), a wide area network (WAN) such as the Internet, or a combination of the two, and include wired, wireless, or fiber optics connections. In general, network 340 can be any combination of connections and protocols that will support communications between computing system 310, cloud platforms 320, and data sources 330.

FIG. 4 is a flowchart depicting a service selection method 400 in accordance with at least one embodiment of the present invention. As depicted, platform selection method 400 includes receiving (410) a set of client requirements, analyzing (420) available service providers based on client requirements, identifying (430) one or more unstructured external data sources, analyzing (440) reliability of the one or more unstructured external data sources, adjusting (450) the scoring of the service providers based on the data source reliability, and providing (460) an optimal selection of service providers based on the adjusted scoring.

Receiving (410) a set of client requirements may include receiving, from a client seeking one or more services, a set of requirements corresponding to said one or more services. For example, a client may require that a single service be fulfilled as a whole by only one provider; in other words, with respect to such a requirement, if a part of the service is fulfilled by one provider, another part of the same service cannot be fulfilled by an additional provider. Receiving (410) a set of client requirements may additionally include processing the received client requirements to create an updated set of requirements with respect to which requirement is fulfillable by a single service provider. In an embodiment where a requirement requires multiple service providers to be fulfilled, receiving (410) a set of client requirements includes splitting said requirement into multiple sub-requirements such that each sub-requirement can be satisfied by a single provider. Receiving (410) a set of client requirements may additionally include receiving one or more constraints corresponding to each requirement. For example, a constraint of a client requirement may be that two or more services or requirements must be met by a same provider. Another example of a constraint of a requirement would be a price range for each service or requirement. Receiving (410) a set of client requirements may additionally include a ranking or weight corresponding to each service, requirement, and/or constraint reflecting the importance of each of the preceding aspects as indicated by the client. In at least some embodiments, receiving (410) a set of client requirements additionally includes determining required resources corresponding to the set of client requirements.

Analyzing (420) available service providers based on client requirements may include receiving or identifying a list of available providers. Analyzing (420) available service providers may include determining the capabilities of each available service provider, as well as the available capacities of required resources with respect to each available service provider. In at least some embodiments, analyzing (420) available service providers additionally includes identifying structured historical data corresponding to each service provider. Structured historical data may include provider quality of service (QoS) data provided by clients or captured by a system, wherein said data may include client attributes, workload attributes, structured client constraints, or other data indicative of the nature of the workload managed by the service provider with respect to the historical client(s). In at least some embodiments, structured historical data may additionally include measured QoS metrics such as average response times and longest response times. In general, analyzing (420) available service providers based on client requirements may include querying the available service providers for available QoS data retained by the providers. In at least some embodiments, analyzing (420) available service providers includes querying previous clients for QoS data. Analyzing (420) available service providers may additionally include filtering available service providers according to requirements, such that providers objectively unable to meet one or more client requirements may be excluded from additional analysis. Additionally, analyzing (420) available service providers may include determining whether the provider has requirements which cannot be met by the client. Subsequently, any available service providers which have requirements which cannot be met by the client may be excluded from analysis. In at least some embodiments, analyzing (420) available service providers based on client requirements additionally includes requesting pricing from each provider for each service or requirement. Analyzing (420) available service providers based on client requirements may additionally include scoring the available service provider according to their ability to meet the client requirements.

Identifying (430) one or more unstructured external data sources may include identifying data sources via which unstructured QoS data is available. Unstructured QoS data may refer to expert reports, ratings, or reviews of providers, news outlet analysis of the providers, or any additional labels of confidence in the provider. In at least some embodiments, requirements gathered from engaging interactions with client and providers are stored in dictionary format along with structured QoS data. The information stored may contain entities extracted from natural language analysis executed with respect to the identified unstructured data.

Analyzing (440) reliability of the one or more unstructured external data sources may include identifying the capabilities of the one or more unstructured external data sources. In at least some embodiments, analyzing (440) reliability of the one or more unstructured external data sources includes analyzing available documentation corresponding to the data sources to identify the pertinent capabilities. Analyzing (440) reliability of the one or more unstructured external data sources may include querying public standard datasets which provide analysis of one or more data sources to determine a reliability of said data sources. Analyzing (440) reliability of the one or more unstructured external data sources may additionally include determining a factor by which to adjust corresponding scores or scorings based on the reliability of said one or more unstructured external data sources.

Adjusting (450) the scoring of the service providers based on the data source reliability may include combining the historical QoS data and the unstructured QoS data for each provider and each service. In at least some embodiments, adjusting (450) the scoring of the service providers includes using a weighting function to combine both scores. Such a weighting function could be any ensemble method, or a simple function (min, max, average, etc.). In general, adjusting (450) the scoring of the service providers based on the data source reliability includes generating a scoring corresponding to the service providers that reflects the analyzed reliability of the corresponding data sources contributing to the initial scoring of said providers.

Providing (460) an optimal selection of service providers based on the adjusted scoring may include building an optimization model that allocates providers to each client requirement. In some embodiments, providing (460) an optimal selection of service providers includes providing a ranking of each provider with respect to each service, requirement, or constraint. In at least some embodiments, the model is an integer programming assignment model, where the variables are, for example, x_{ijk], wherein x is 1 if provider “i” is to be assigned to requirement j of client k, and x is 0 otherwise. In at least some embodiments, the integer programming assignment model is configured to maximize a sum of the scores of the allocated provider-requirement pairs, putting in consideration weights of the requirements as indicated by the client. In at least some embodiments, the constraints of the model capture the provider capacities (the sum of the resources required for the client requirements allocated to a provider cannot exceed the available capacities of the resources at that provider), the client requirements (some clients may restrict a particular requirement to a specific provider, where other clients might restrict a particular requirement from being allocated to a specific provider), and budget constraints for the price ranges of providers assigned to the services. In at least some embodiments, providing (460) an optimal selection of service providers includes providing a separate output for each provider-requirement (or provider-service) pair. Providing (460) an optimal selection of service providers may include determining whether selecting a single provider for two or more services (or requirements) enables one or more benefits; similarly, providing (460) an optimal selection of service providers may include whether any two providers may complement one another if leveraged with respect to two or more services.

In at least some embodiments, service selection method 400 additionally includes training a machine learning classifier and/or a multi-variable regression model to predict a provider's Quality of Service level. Service selection method 400 may include analyzing text corresponding to the provider's QoS, counting word frequencies with respect to terms of interest, normalizing said frequencies (for example, by dividing them by the frequency of the term of interest in a whole history of the analyses of the provider), and then using the normalized frequencies as features in a classification model. In general, a Term Frequency-Inverse Document Frequency (TF-IDF) technique may be leveraged to conduct analysis of the providers QoS. Subsequently, given current new workload unstructured data, the created machine learning classifier model can be used to convert that data, identify the corresponding word/corpus frequencies, and classify the new workload accordingly. In some embodiments, the model may be configured to give a weight to each class that the new provider is predicted to belong to, such that the weight is indicative of how closely the new workload unstructured data matches the unstructured data of providers in the pertinent classes.

In at least some embodiments, service selection method 400 additionally includes a combination improvement mechanism enabled through federated learning. For example, with respect to security, combined score generation for the combination of providers and their storage in real-time for predictive analytics and decision making may reflect the benefits of combined services. Security scores may be generated with respect to compatibilities, data leaks, and vulnerabilities. With respect to stability, much like with respect to combined score storage from the aspect of stack stability and maintenance cost, some combinations may be beneficial as a combination even if two other providers perform better individually. Stability scores may be generated with respect to long term maintainability and maintenance cost, as well as stack robustness and stability. In general, a combination performance score is generated, monitored, and stored in near real-time to make optimization decisions based on metadata corresponding to the above described factors. Combination scores may be calculated over time reflecting historical data regarding how service providers have performed when implemented together.

In at least some embodiments, service selection method 400 additionally includes an opt-in analytics mechanism in which a service provider can analyze which of the services they provide were over-looked by customers in favor of another provider. The opt-in analytics mechanism may additionally include an aggregated approximation metric which signifies the magnitude by how much one service provider was favored over another.

In at least some embodiments, the providers analyzed by service selection method 400 belong to a consensus framework wherein multiple agents interact with each other along a supply chain management platform P, wherein each of the agents refer to different providers of specific services/resources. Consider said agents A to be a subset of a plurality of decision agents A={A₁, A₂, . . . , Aₙ} wherein A₁ to Aₘ provide x services with y cost, and Aₘ₊₁ to Aₙ₋₂ provide z services with q cost. Based on the optimization and sensitivity analysis, the reduced cost and provision of service x is opted from the ranked list from A₁ to Aₘ, wherein the multi-agent reinforcement learning model optimizes the reward function, also taking into consideration feedback from previous runs. In at least some embodiments, a Multi-Agent Reinforcement Learning (MARL) reward function is used for this equation, wherein said user agents compare services being offered with available QoS information. Service selection method 400 may additionally include conglomerating node capacity requirements for said services and feeding back to the user's requirements for optimal service segregation O. Thus, the software agents automate the optimal service segregation mechanism. MARL functions running on different provider platforms altering services and infra strategy to segregate provisioning of said services via subset of specific providers may be showcased to the user in a conglomerated fashion. Any user response to said output may be monitored in order to provide active feedback to roll back into the state parameters of the MARL algorithm. A contrastive explainability algorithm may be used to provide explanation behind the service segregation, taking into account both pertinent positive factors and pertinent negative factors contributing to the distribution of services.

In at least some embodiments, service selection method 400 additionally includes training a machine learning model to identify optimal service provider selections based on scoring adjustments made with respect to external data source reliability. In such embodiments, service selection method 400 may include training the model to adjust service provider scorings according to previously identified factors. In at least some embodiments, training a machine learning model to identify optimal service provider selections includes training the model to identify similarities between new external data sources and previously analyzed external data sources, and generate scoring factors according to those similarities.

In at least some embodiments, service selection method 400 additionally includes utilizing the optimal selection of service providers to execute required IT functions. Utilizing the optimal selection of service providers may include providing necessary data to the one or more service providers to enable the service providers to execute said required IT functions. In at least some embodiments, utilizing the optimal selection of service providers may include giving the one or more service providers controlled access to one or more resources required to execute said required functions. In general, utilizing the optimal selection of service providers may include enabling the service providers to execute their contracted functions via whatever mechanisms necessary, such as enabling access, providing data, or otherwise.

FIG. 5 depicts a block diagram of components of computing system 310 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

As depicted, the computer 500 includes communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media.

One or more programs may be stored in persistent storage 508 for access and/or execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links.

I/O interface(s) 514 allows for input and output of data with other devices that may be connected to computer 500. For example, I/O interface 514 may provide a connection to external devices 520 such as a keyboard, keypad, a touch screen, and/or some other suitable input device. External devices 520 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 508 via I/O interface(s) 514. I/O interface(s) 514 also connect to a display 522.

Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for selecting service providers, the computer implemented method comprising:
receiving a set of client requirements;
analyzing available service providers based on the received set of client requirements;
scoring the available service providers according to the analysis;
identifying one or more unstructured external data sources corresponding to the available service providers;
analyzing reliability of the one or more unstructured external data sources with respect to the available service providers;
adjusting the scoring of the service providers based on the data source reliability;
training a machine learning model to identify optimal service provider selections according to the adjusted scoring; and
providing an optimal selection of service providers based on the adjusted scoring.

2. The computer implemented method of claim 1, wherein analyzing available service providers includes determining capabilities of each available service provider with respect to the received set of client requirements.

3. The computer implemented method of claim 1, further comprising determining available capacities of required resources corresponding to the set of client requirements with respect to each available service provider.

4. The computer implemented method of claim 1, further comprising building an optimization model to allocate service providers according to the adjusted scoring.

5. The computer implemented method of claim 4, wherein the optimization model is an integer programming assignment model.

6. The computer implemented method of claim 1, further comprising utilizing the optimal selection of service providers to execute one or more functions.

7. The computer implemented method of claim 1, further comprising enabling an opt-in analytics mechanism configured to determine whether different providers can complement each other to provide increased efficiency.

8. A computer program product for selecting service providers, the computer program product comprising:
one or more computer readable storage media and program instructions stored on the one or more computer readable storage media, the program instructions comprising instructions to:
receive a set of client requirements;
analyze available service providers based on the received set of client requirements;
score the available service providers according to the analysis;
identify one or more unstructured external data sources corresponding to the available service providers;
analyze reliability of the one or more unstructured external data sources with respect to the available service providers;
adjust the scoring of the service providers based on the data source reliability;
train a machine learning model to identify optimal service provider selections according to the adjusted scoring; and
provide an optimal selection of service providers based on the adjusted scoring.

9. The computer program product of claim 8, wherein instructions to analyze available service providers comprise instructions to determine capabilities of each available service provider with respect to the received set of client requirements.

10. The computer program product of claim 8, wherein the program instructions further comprise instructions to determine available capacities of required resources corresponding to the set of client requirements with respect to each available service provider.

11. The computer program product of claim 8, wherein the program instructions further comprise instructions to build an optimization model to allocate service providers according to the adjusted scoring.

12. The computer program product of claim 11, wherein the optimization model is an integer programming assignment model.

13. The computer program product of claim 12, wherein the program instructions further comprise instructions to utilize the optimal selection of service providers to execute one or more functions.

14. The computer program product of claim 8, wherein the program instructions further comprise instructions to enable an opt-in analytics mechanism configured to determine whether different providers can complement each other to provide increased efficiency.

15. A computer system for selecting service providers, the computer system comprising:
one or more computer processors;
one or more computer-readable storage media;
program instructions stored on the computer-readable storage media for execution by at least one of the one or more processors, the program instructions comprising instructions to:
receive a set of client requirements;
analyze available service providers based on the received set of client requirements;
score the available service providers according to the analysis;
identify one or more unstructured external data sources corresponding to the available service providers;
analyze reliability of the one or more unstructured external data sources with respect to the available service providers;
adjust the scoring of the service providers based on the data source reliability;
train a machine learning model to identify optimal service provider selections according to the adjusted scoring; and
provide an optimal selection of service providers based on the adjusted scoring.

16. The computer system of claim 15, wherein the program instructions further comprise instructions to determine available capacities of required resources corresponding to the set of client requirements with respect to each available service provider.

17. The computer system of claim 15, wherein the program instructions further comprise instructions to build an optimization model to allocate service providers according to the adjusted scoring.

18. The computer system of claim 17, wherein the optimization model is an integer programming assignment model.

19. The computer system of claim 18, wherein the program instructions further comprise instructions to utilize the optimal selection of service providers to execute one or more functions.

20. The computer system of claim 15, wherein the program instructions further comprise instructions to enable an opt-in analytics mechanism configured to determine whether different providers can complement each other to provide increased efficiency.
